(19) United States
(12) Patent Application Publication
(10) Pub. No.: US 2009/0235633 A1
(43) Pub. Date: Sep. 24, 2009

(54) Integrated process plant utilizing a fractionating auxiliary treatment system

(76) Inventor: Howard Simons, Middx (GB)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/662,511

(22) PCT Filed: Sep. 9, 2005
(86) PCT No.: PCT/GB05/03495

§ 371 Date: Mar. 23, 2009

(30) Foreign Application Priority Data
Sep. 9, 2004 (GB) 0420041.6

(51) Int. Cl. F02C 6/18

(52) U.S. Cl. 60/39.12; 60/39.511

(57) ABSTRACT

An integrated power plant comprising a gas turbine set with a compressor, a combustion chamber and a gas turbine, a waste heat recovery unit (WHRU) arranged downstream of the gas turbine, the heat from the gas turbine flue gases being recovered directly in the WHRU in a coil fed by hydrocarbons or other process fluid. The resulting two-phase hydrocarbon or process stream leaving the WHRU is separated into a vapour and liquid stream using a Fractionating Auxiliary Treatment (FAT) system.

The present invention relate to the field of integrated process plants and more particularly to power plant technology. It concerns a high level integrated approach directed at improvements in environmental models when integrating new power generating facilities with existing ones. The approach provides a way of reducing the level of environmentally damaging emissions from process plants at a complex-wide level rather than at a local apparatus level. The concept is deployed through a number of “integration schemes” which focus on recovering heat and then re-deploying this heat to save fuel and reduce emissions.

In a typical combined heat and power (CHP) plant, electricity is produced by firing a gas turbine on available natural gas, refinery fuel gas, or other fuel sources and recovering heat from the gas turbine flue gas. There are various existing ways in which CHPs are operated. Combined cycle power plants use the hot flue gas from the gas turbine in a waste heat recover unit (WHRU) to produce steam which is converted back to electrical energy. Other conventional CHP systems directly utilise the steam produced in the WHRU. Another approach to using flue gas energy is to apply it directly to a hydrocarbon stream. In this case, the hydrocarbon stream leaving the WHRU is transported back to the process unit as a liquid (hot oil systems) or as a two-phase fluid.

The combined cycle CHP plant is a commonly-used and well-known prior art. In fact, a n entire International Patent Classification (IPC) designation exists for which gas turbine waste heat is utilised in such a way as previously described. The referenced IPC designation is IPC F01K23/10 which refers to processes “using waste heat of a gas turbine for steam generation or in a steam cycle”. There have been improvements and varying methods to the utilisation of the combined cycle CHP since its introduction, but the intrinsic features of the combined cycle CHP remain the same. In such a way, the combined cycle CHP plant is only able to achieve 50-60% thermal efficiency.

Another CHP plant waste heat application commonly used is one in which a CHP plant utilises gas turbine waste heat for district heating. Such a method is described in U.S. Pat. No. 6,347,520. Despite the advantages of this system and method, further efficiency improvements are highly desirable.

It is also a well-established method to use CHP gas turbine waste heat to directly transfer heat to a hydrocarbon in the gas turbine WHRU, as suggested in the current invention. Such a method is described in U.S. Pat. No. 6,510,695. In this method, an organic wording fluid (eg, n-pentane, isopentane) may be made responsive to hot exhaust gases from a gas turbine. In such a way, the vaporized organic working fluid may be used for producing power by expanding the organic vapour in a turbine. This method is very similar to combined cycle power plants in which steam is used in the place of an organic working fluid, but serves to illustrate the verified direct integration of a hydrocarbon in a gas turbine WHRU.

Still another method which approaches gas turbine waste heat utilisation in a fashion similar to the present invention is described in an article entitled “Gas Turbines for Crude Oil Heating; New Process Integration Opportunities for Refineries” presented by Jacobs Consultancy at the Powered Conference, Brussels 2001. In this paper, a typical Western European refinery is taken to describe such a cogeneration concept in which crude oil is heated before it enters the crude distillation column by means of utilising hot flue gases from a power generating gas turbine. This concept has been in application since 1992 in the Shell Fredericia Refinery (Denmark) and is successfully operating without any problems. In this case, hot flue gases from a gas turbine are directed into a WHRU to transfer heat to crude oil. Typically, the crude oil enters the WHRU section as a single-phase liquid flow and leaves to the crude tower as two-phase flow via a crude transfer line. One aspect to take into account here is that the resulting two-phase flow velocities must be sufficient to achieve stable flow regimes in the crude transfer line. This presents a limitation to the method as it typically only allows the crude to be heated to temperatures at which 40-60% is vaporised equating to only approximately 50% heat pick up. A safety concern also arises at this point, as the circumstances must be considered in which slug flow could occur in the transfer line to the crude tower making it necessary for the line to be sufficiently supported to provide protection against this case. This becomes an exhaustive and economically undesirable situation, as the large line to the crude tower is typically located 30 meters above ground.

It is an object of the present invention to overcome the differentials of the prior proposals and to increase the overall efficiency of a process plant.

The present invention provides an integrated process plant comprising a power generation unit arranged to burn fuel and produce hot flue gases, a processing unit arranged to process a fluid, and a waste heat recovering unit arranged to recover heat from the flue gases of the power generation unit and transfer recovered heat to the process fluid so as to create a two phase process stream, characterised in that

a vapour/liquid separation unit is provided for receiving the two-phase process stream and generating separate single-phase vapour and liquid streams.

In the case of a preferred embodiment of the present invention, natural gas, refinery fuel gas, or other fuel source is used as a fuel to a gas turbine. Electricity generated by the gas turbine can be used to supply the needs of a neighbouring process plant and the excess exported to the grid. The heat from the gas turbine flue gases will be recovered in a WHRU in a steam coil as an option and directly in a hydrocarbon or process coil. The preferred embodiment is fundamentally different from the existing CHP concepts in that the two-phase hydrocarbon or process stream (excluding water/steam) leaving the WHRU is separated into vapour and liquid streams using a fractionating auxiliary treatment (FAT) system. This removes the necessity of returning a two-phase flow back to the process area from the WHRU. In contrast to the previously descried method in which two-phase flow is returned to the process area with a limitation of 50% heat pick up, the present embodiment allows for up to 70% heat pick up as a result of the phase separation.

In order that the present invention be more readily understood, an embodiment thereof will now be described by way of example with reference to the accompanying drawings, in which:

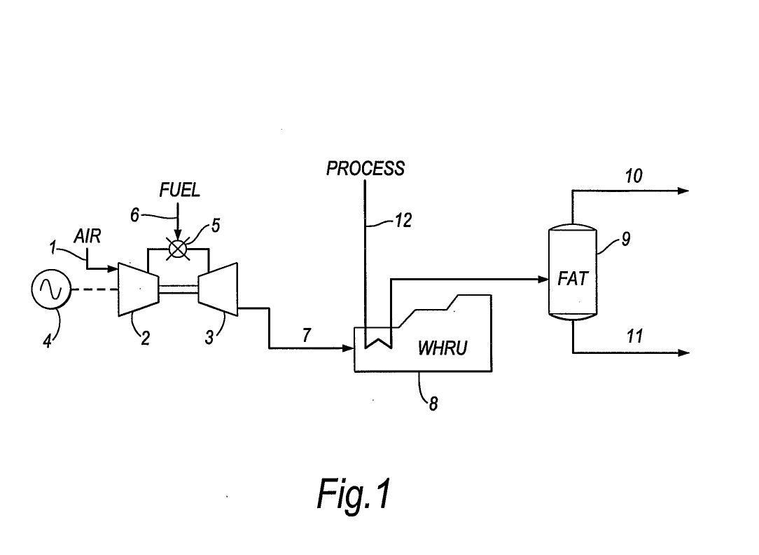

FIG. 1 shows a part of an integrated process plant according to the present invention; and

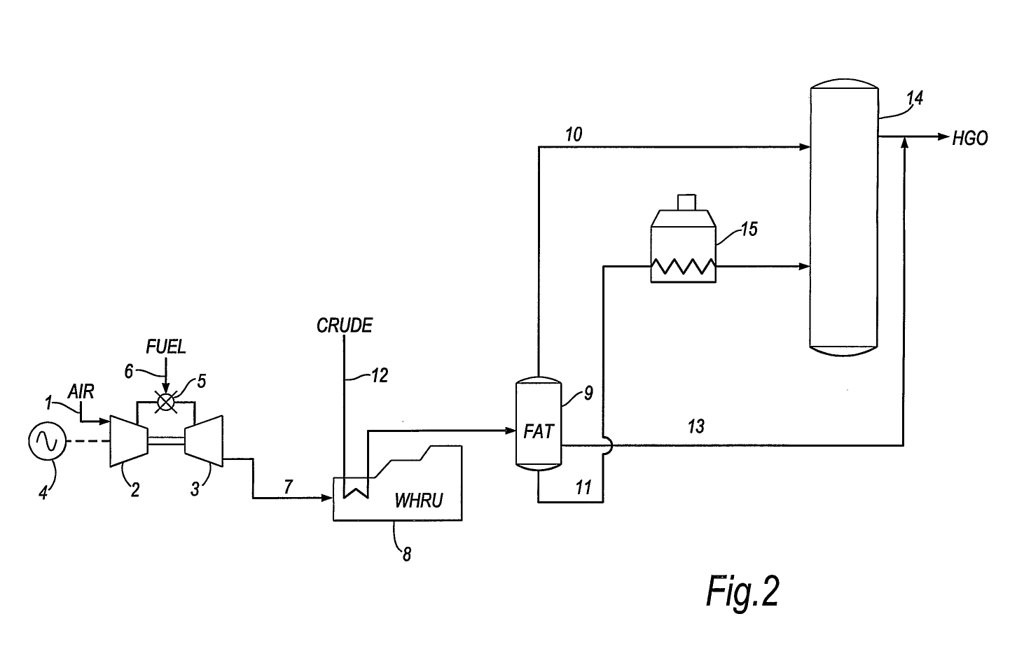

FIG. 2 shows a larger process plant incorporating the present invention.

Referring to FIG. 1, a preferred embodiment of the present invention utilises a gas turbine as a power plant within an integrated process plant.

Combustion air 1 for the power plant is drawn from the atmosphere and compressed to a final combustion pressure by means of an air compressor 2. The compressed air is then delivered from the compressor 2 to a combustion chamber 5. The compressed air is mixed with fuel 6 to enable combustion. The fuel 6 is provided by natural gas/refinery fuel from a neighbouring processing complex or from another fuel source. The resultant combustion gases are then ducted through a pipeline 5 to a gas turbine 3. The combustion gases are expanded in the turbine 5 where they give up mechanical energy and are then transferred by pipeline 7 to a WHRU 8. The turbine 5 drives the compressor 2 and transfers power to an electrical generator 4. A non-aqueous process stream from a neighbouring processing complex is fed into the WHRU 8 where the heat from the gas turbine flue gases is recovered in a process coil 12 resulting in a partially vaporized process stream. This two phase process stream leaving the WHRU 8 is then sent to an adjacent separation unit eg a FAT system 9 where the process stream is separated into a vapour stream 10 and a liquid stream 11.

The FAT system 9 is located as close as possible to the WHRU commensurate with safety. Currently the FAT system 9 cannot be closer than 50 ft and for mechanical engineering reasons should be within 50 m of the WHRU 8 which itself should be as close as possible to the gas turbine unit.

As previously explained, the CHP plant and the utilisation of gas turbine waste heat is a documented and well-known technology. Neither can it be said that the method of vapour-liquid separation is a new technology. Various methods and techniques exist in which to effect the separation of vapour and liquid phases (eg flashing, stripping, absorption, etc). It is the combination of these two existing technologies in such a high level integrated approach that provides the novelty of the current invention.

The basis of the approach in the current invention is to exploit the synergies between a combined heat and power system and neighbouring processing plants so as to improve the overall system efficiency and reduce environmentally damaging emissions of the complex as a whole. The integration schemes presented demonstrate that emissions reduction can be achieved without introducing operability complexities, whilst increasing product yield.

The current invention is derived from the establishment of a general utility provider, or “Utility Island”, which centralises heat and power sources and then distributes it to the various process complexes in the form of utilities, and/or direct process stream heating. This Utility Island forms the utilities hub of the whole processing complex and is the focus for the site-wide integration. Thus, the separation unit 9 is preferably located on the “Utility Island” together with the power plant and WHRU.

The Utility Island is based on a CHP plant, which typically consists of one, two or more gas turbine generators (GTG) and a WHRU. Conventional CHP plants use steam turbine generators and auxiliary boilers in addition to GTGs and are designed to satisfy both the site power and process heating demands (addressed through steam export). The Utility Island concept shifts the priority to designing the CHP system for maximum waste heat generation. This normally requires over-sizing of the CHP plant for power generation and dispensing with steam turbine generators and auxiliary boilers. To be cost effective, power not consumed within the complex must be exported to the local grid. The oversized GTG's provide a high exhaust flow from which heat is recovered in the WHRU for utility generation (steam) and process heating.

The Utility Island removes the need for localised high grade process heating in furnaces. Fuel is supplied to the island from the process and heat and power exported. This coupling enables integration and exporting of high, medium and low grade heat. The efficiency improvement comes from improved utilisation of the water heat from power generation, rather than burning fuel specifically for process heating purposes. A conventional CHP is less than 60% thermally efficient, whilst the Utility Island concept can achieve over 75% efficiency.

Typically, the realise a marked efficiency improvement, the Utility Island needs to be deployed in conjunction with several processing complexes utilising both high and low grade heat, ie refineries or other process plants. This ensure that as much of the available exhaust heat possible is utilised and the thermal efficiency maximised.

The current invention is implemented through establishment of a Utility Island and the subsequent integration of energy efficient schemes between the Island and neighbouring processes. These schemes aim to substitute process fuel firing with waste heat recovery systems integrated with the Utility Island. Providing the initial process firing scheme is maintained, then it may still be operated independently of the Utility Island. This maintains operational flexibility in the event of a Utility Island failure.

The Utility Island concept is driven by the requirement to economically maximise the available heat for process uses and utility generation, rather than for specific power generation. Hence, the CHP system is oversized for power production and the surplus power is exported to the grid. The power and heat demands are supplied entirely by the gas turbines and generators; steam turbines and auxiliary boilers are dispensed with a steam is generated directly from heat recovery in the WHRU. As more direct process heat recovery schemes are introduced into the WHRU, so the heat available for steam generation decreases. The Utility Island approach sacrifices steam generation to utilise the high grade waste heat for direct process heating, thus saving furnace fuel.

A preferred embodiment of the present invention is shown in FIG. 2 where the same reference numerals as used in FIG. 1 are used to designate the same parts.

In FIG. 2, the process stream is a crude stream from a neighbouring refinery which is fed into the WHRU 8 where the heat from the gas turbine flue gases is recovered in a process coil 12 resulting in a partially vaporized crude stream. The two phase crude stream leaving the WHRU 8 is then sent to the adjacent FAT system 9 where the crude stream leaving the WHRU 8 is then sent to the adjacent FAT system 9 where the crude stream is separated into a vapour stream 10 and a liquid stream 11. The bottom liquid product stream 11 is sent to the flash zone of the existing refinery crude tower 14 via the existing crude furnace 15. The vapour stream 10 is routed back to the crude tower 14 overhead but at a location in the heavy gas oil (HGO) section. An additional HGO product stream 13 is also a by-product from the FAT tower 9.

One benefit of this embodiment is that it unloads a crude preheat furnace 13 by heating crude directly in the WHRU. After heating, the crude may be treated in the proprietary Fractionation Auxiliary Treatment (FAT) system, which is integrated without a major revamping to the crude tower being necessary. This proprietary design not only saves fuel in the crude furnace but also debottlenecks the crude tower enabling increased throughput.

In order to maximise the efficiency of the CHP system it is necessary to recover and utilise as much of the low grade heat as possible. If not recovered this heat would have to be rejected, significantly reducing the efficiency of the overall system. There exist two principal methods of extracting this low grade heat from the WHRU;

i) closed loop circuits; involve circulating a fluid through a set of heating coils in the WHRU, extracting the waste heat, and then transferring this heat to the process before recirculating the cooled fluid back to the WHRU. The method of heat extraction from the exhaust is identical to that used for steam generation or process heating, and consists of heating tubes running across the exhaust duct.

ii) open loop circuits; extract waste heat by direct contacting with a quenching fluid (usually water) in a packed column. Prior to expulsion through the stack, hot exhaust gases are directed through the column where the heat is recovered by direct quenching with the wash fluid.

Open loop circuits have a better heat recovery than closed loop circuits as the exhaust gases are cooled to within a few degrees of the quenching fluid temperature (typically near ambient), whereas closed loop systems require the exhaust gases to exit the stack at approximately 50° C. above the dew point temperature. The disadvantage of open loop systems is that quench fluid exits the system at a considerably lower temperature (typically 65° C. maximum) than that which can be achieved with a closest loop system and hence the fluid flow rates are considerably higher leading to high pumping and piping costs. Additionally, for systems where water is used as the quench fluid, the high level of CO₂ dissolution means the entire contacting column needs to be fabricated from low acidity resistant material.

The use of closed loop circuits is well established and has been used successfully in a variety of applications for a range of GTG units. However, the use of open loop circuits is still relatively new and to date has only been used with small CHP installations in conjunction with LNG terminals.

We propose that the WHRU 8 is in the form of a packed column through which the process fluid, in this and crude oil, is passed in order to provide for open loop heat transfer with the exhaust gases from the GTG.

1. An integrated process plant comprising a power generation unit arranged to burn fuel and produce hot flue gases, a processing unit arranged to process a fluid, and a waste heat recovering unit arranged to recover heat from the flue gases of the power generation unit and transfer recovered heat to the process fluid so as to create a two phase process stream, characterised in that
a vapour/liquid separation unit is provided for receiving the two-phase process stream and generating separate single-phase vapour and liquid streams.

2. An integrated plant as claimed in claim 1, wherein the separating unit is a fractionating auxiliary treatment system.

3. An integrated plant as claimed in claim 1, wherein the separation unit is arranged to perform separation by one of flashing, stripping or absorption.

4. An integrated plant as claimed in claim 1, wherein the power generation unit is a gas turbine set with a compressor, combustion chamber and output turbine.

5. An integrated plant as claimed in claim 1, wherein the processing unit is a refinery or gas terminal.

6. The integrated plant as claimed in claim 5, in which the gas turbine is fuelled by natural gas/refinery fuel gas/other fuel source supplied by the processing unit.

7. The integrated plant as claimed in claim 5, whereby electricity generated by the gas turbine can be used to supply the needs of the processing unit and the excess exported to the local grid.

8. The integrated power plant as claimed in claim 4, whereby the process heating required by the neighbouring process complex is provided by the heat from the gas turbine flue gasses ion the WHRU.

9. The integrated power plant as claimed in claim 1, in which the process plant is designed for maximum waste heat generation, enabling integration and export of high, medium and low grade heat.

10. The integrated power plant as claimed in claim 1, in which the WHRU additionally includes a steam coil for recovering additional heat from the flue gases.

11. The integrated plant as claimed in claim 5, wherein the processing unit is a refinery in which heat is recovered in the WHRU to partially vaporise a crude stream; phase separation of the crude then takes place in the FAT system from which the bottom liquid product is sent via a crude furnace to an existing crude tower but at a location in the heavy gas oil (HG)) section; an additional HGO product stream is a by-product from the FAT system.

12. The integrated plant as claimed in claim 4, wherein the FAT system may be used as a reboiler for a neighbouring process complex distillation tower using the gas turbine waste heat for reboil duties in a deisopentaniser or a deisohexamiser column.

13. An integrated plant as claimed in claim 5, wherein integration with the neighbouring process unit is part of a revamp and the power unit is located a distance away from the process complex.

14. The integrated plant as claimed in claim 5, wherein the integration with the neighbouring process unit is a grassroots complex and may be built around or in close proximity to the power plant.
